(19) United States
(12) Patent Application Publication
(10) Pub. No.: US 2026/0100082 A1
(43) Pub. Date: Apr. 9, 2026

(54) HOME SECURITY DEVICE WITH DISPLAY DEVICE

(71) Applicant: Iris Optronics Co., Ltd., Tainan City (TW)

(72) Inventors: Cheng Yu LIN, Kaohsiung City (TW); Cheng Hong YAO, Tainan City (TW); Chi Chang LIAO, Tainan City (TW)

(21) Appl. No.: 19/346,530

(22) Filed: Sep. 30, 2025

Related U.S. Application Data
(60) Provisional application No. 63/703,185, filed on Oct. 3, 2024.

(30) Foreign Application Priority Data
Mar. 17, 2025 (TW) 114109766
Mar. 17, 2025 (TW) 114202613

(51) Int. Cl. G07C 9/00; G01S 7/51; G01S 17/894; G02F 1/1335; G02F 1/1343; G06F 3/147; G06V 10/30; G06V 40/10; H04N 23/20; H04N 23/56

(52) U.S. Cl. CPC G07C 9/00563; G01S 7/51; G01S 17/894; G06V 10/30; G06V 40/10; H04N 23/20; G02F 1/133512; G02F 1/13439; G06F 3/147; H04N 23/56

(57) ABSTRACT

A home security device with a display device includes a home security device body, the display device, a detecting device and a controller. The display device is disposed on a side of the home security device body, and includes at least one display module and a light absorbing module. The display module includes a pixel matrix layer. The light absorbing module is disposed on a side of the display module. The detecting device is disposed on a side of the display device so as to obtain an image of a user. The controller is signally connected to the home security device body, the display device and the detecting device, the controller is configured to control the display device to display an image information, and the controller is configured to recognize the image to confirm whether to unlock the home security device body.

### RELATED APPLICATIONS

This application claims priority to U.S. Provisional Application Ser. No. 63/703,185 filed Oct. 3, 2024, Taiwan Application Serial Number 114109766, filed Mar. 17, 2025 and Taiwan Application Serial Number 114202613, filed Mar. 17, 2025, which are herein incorporated by references.

### BACKGROUND

### Technical Field

The present disclosure relates to a home security device. More particularly, the present disclosure relates to a home security device with a display device.

### Description of Related Art

To provide the user with the safe place to store the valuables and the important documents and the home security, the home security devices, such as the coffers disposed at home or the office or the electronic door locks, are gradually common. Further, a portion of the users hide the coffers or the electronic door locks behind the paintings or the photos which are decorative so as to the requirements of the concealment and the aesthetic.

However, in addition to the requirements of making the pictures which is special for fitting the dimension of the outer frame when replacing the paintings or the photos, the paintings or the photos above the coffers or the electronic door locks have to be removed before opening the coffers or the electronic door locks. Hence, it causes the inconvenience in use and lack of the security and the privacy.

Therefore, the recent market is short of the home security device, which can both achieve the effects of the convenience and the safety, and hence the aforementioned home security device needs to be developed.

### SUMMARY

The present disclosure provides a home security device with a display device, which includes a home security device body, the display device, a detecting device and a controller. The display device is disposed on a side of the home security device body, and includes at least one display module and a light absorbing module. The display module includes a pixel matrix layer. The light absorbing module is disposed on a side of the display module. The detecting device is disposed on a side of the display device so as to obtain an image of a user. The controller is signally connected to the home security device body, the display device and the detecting device, the controller is configured to control the display device to display an image information, and the controller is configured to recognize the image to confirm whether to unlock the home security device body.

### BRIEF DESCRIPTION OF THE DRAWINGS

FIG. 1 is a three-dimensional schematic view of a home security device with a display device according to the 1st example of the present disclosure.

FIG. 2 is a cross-sectional schematic view of the home security device with the display device according to the 1st example in FIG. 1.

FIG. 3 is a block diagram of the home security device with the display device according to the 1st example of the present disclosure.

FIG. 4A is a schematic view of a display device according to the 2nd example of the present disclosure.

FIG. 4B is a schematic view of a display device according to the 3rd example of the present disclosure.

FIG. 5A is a schematic view of a light absorbing module according to the 4th example of the present disclosure.

FIG. 5B is a schematic view of a light absorbing module according to the 5th example of the present disclosure.

FIG. 5C is a schematic view of a light absorbing module according to the 6th example of the present disclosure.

FIG. 6 is a three-dimensional schematic view of a home security device with a display device according to the 7th example of the present disclosure.

FIG. 7 is a cross-sectional schematic view of the home security device with the display device according to the 7th example in FIG. 6.

FIG. 8 is a block diagram of the home security device with the display device according to the 7th example of the present disclosure.

FIG. 9 is a three-dimensional schematic view of a home security device with a display device according to the 8th example of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

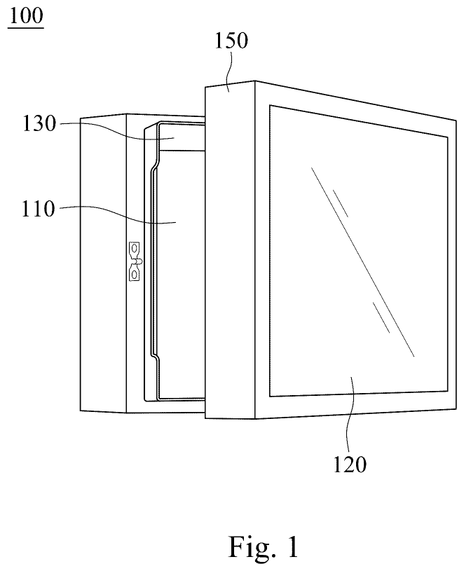

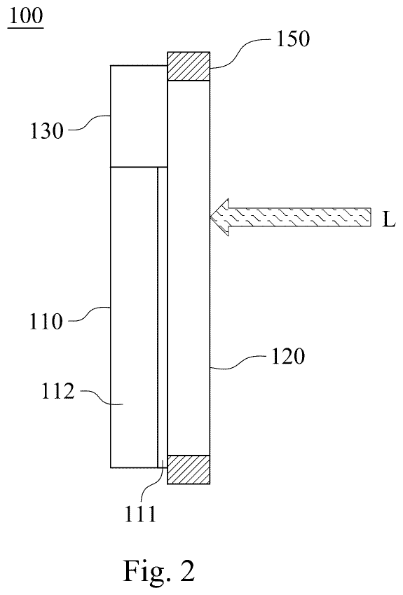

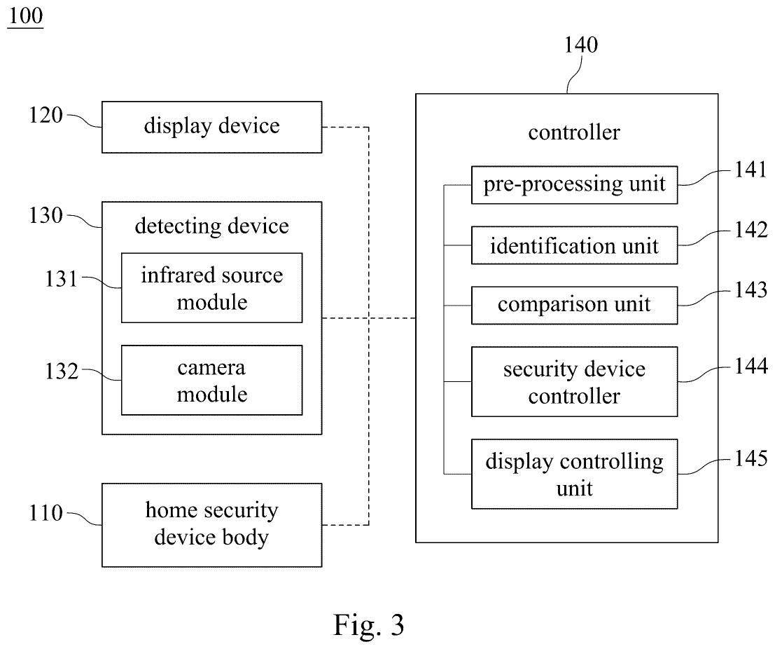

Please refer to FIGS. 1, 2 and 3, wherein FIG. 1 is a three-dimensional schematic view of a home security device with a display device according to the 1st example of the present disclosure; FIG. 2 is a cross-sectional schematic view of the home security device with the display device according to the 1st example in FIG. 1; and FIG. 3 is a block diagram of the home security device with the display device according to the 1st example of the present disclosure. The home security device 100 with the display device 120 includes a home security device body 110, the display device 120, a detecting device 130 and a controller 140.

In FIG. 2, the display device 120 is disposed on a side of the home security device body 110, and the detecting device 130 is disposed on a side of the display device 120 and located on a top of the home security device body 110. In FIG. 3, the controller 140 is signally connected to the home security device body 110, the display device 120 and the detecting device 130. The home security device body 110 is configured to provide a user to store his or her belongings. The display device 120 is configured to display an image information. The detecting device 130 is configured to obtain an image of the user. The controller 140 is configured to control the display device 120 to display the image information, and the controller 140 is configured to recognize the image to confirm whether to unlock the home security device body 110. Further, the home security device 100 with the display device 120 can further include a frame 150 disposed on a periphery of the display device 120.

According to the 1st example, the home security device body 110 can be a coffer; the display device 120 can be a cholesterol liquid crystal display; the detecting device 130 can be an infrared palmprint detecting device; the controller 140 can be a microprocessor, a central processing unit (CPU), a mobile device processor, a cloud processor or other electronic computing processors, but the present disclosure is not limited thereto. Further, the detecting device can be an infrared fingerprint detecting device, an infrared face detecting device or a voiceprint detecting device in other possible examples.

The home security device body 110 includes a door blade 111, a case body 112, an electronic lock and a power source (not shown). An end of the door blade 111 is pivotally connected to the case body 112, the other end of the door blade 111 is selectively disengaged from or engaged with the case body 112 via a latch. The electronic lock is disposed on the door blade 111 and configured to control the latch. The power source is electrically connected to the electronic lock for providing the power of the electronic lock. The display device 120 is connected to the door blade 111 to link with the door blade 111. When the user pulls the display device 120 outwards under the condition of unlocking the electronic lock, the door blade 111 of the home security device body 110 can be simultaneously opened.

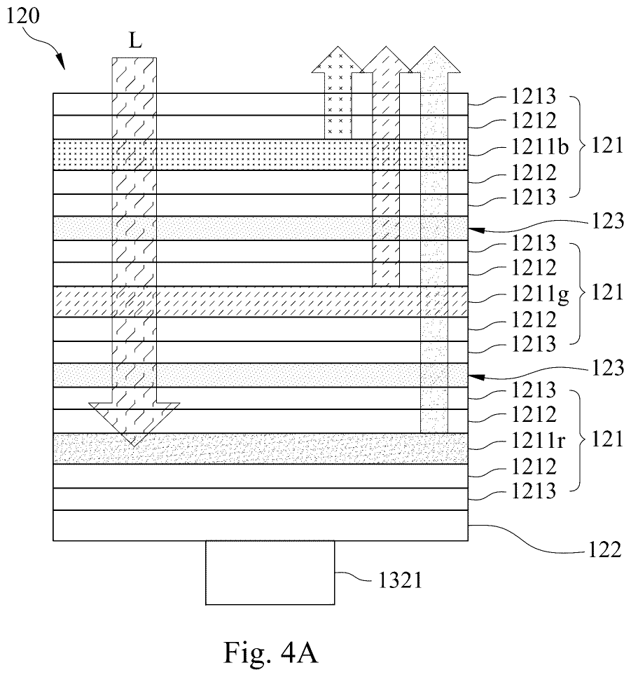

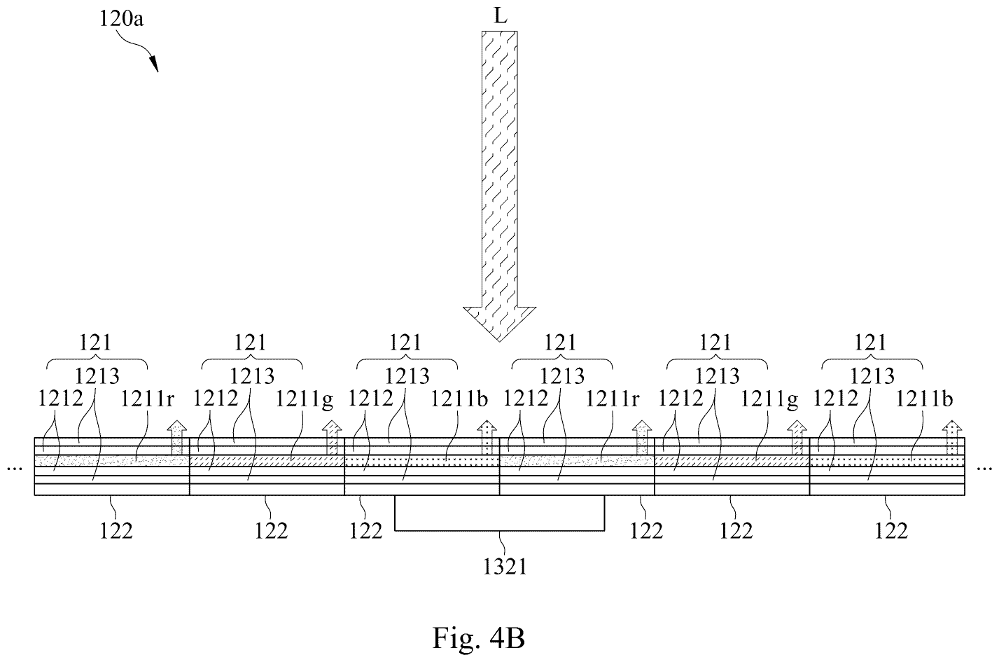

Please refer to FIGS. 2 and 4A, wherein FIG. 4A is a schematic view of a display device according to the 2nd example of the present disclosure. The display device 120 includes at least one display module 121 and a light absorbing module 122, and the light absorbing module 122 is disposed on a side of the display module 121. Further, the display module 121 can be plurality, and the display device 120 can further include at least one optical adhesive layer 123 disposed between the display modules 121 so as to adhere the display modules 121.

The display modules 121 are stackedly disposed, the visible light L can penetrate through the display modules 121 and the light absorbing module 122 in sequence which are stackedly disposed to reach the detecting device 130.

In FIG. 4A, a number of the display modules 121 is three, the three display modules 121 include a pixel matrix layer (as the pixel matrix layers 1211b, 1211g, 1211r which can reflect the blue light, the green light and the red light, respectively, in FIG. 4A), two transparent conductive layers 1212 and two protective layers 1213. The two transparent conductive layers 1212 of each of the display modules 121 are disposed on two surfaces of the pixel matrix layers 1211b, 1211g, 1211r, respectively. The two protective layers 1213 of each of the display modules 121 are disposed on two surfaces of the two transparent conductive layers 1212 away from the pixel matrix layers 1211b, 1211g, 1211r, respectively. According to the 2nd example, the transparent conductive layers 1212 can be made of the transparent conductive material such as Indium-Tin-Oxide (ITO) or Indium-Zinc-Oxide (IZO); the protective layers 1213 can be made of the flexible transparent organic material such as glass or polyethylene terephthalate (PET), but the present disclosure is not limited thereto.

Please refer to FIG. 4B, wherein FIG. 4B is a schematic view of a display device according to the 3rd example of the present disclosure. According to the 3rd example, the display modules 121 are also plurality, and the difference between the display device 120a and the display device 120 according to the 2nd example is the disposition and the number of the display modules 121. In detail, the display modules 121 of the display device 120a according to the 3rd example are parallel disposed, and the display modules 121 are the horizontal structure with the single-layer display. It should be mentioned that the number of the display modules 121 can be adjusted according to the requirements, and the present disclosure is not limited thereto.

The light absorbing module 122 includes a light absorbing layer 1221. The light absorbing layer 1221 is configured to absorb a visible light L penetrating through the display modules 121, and the light absorbing layer 1221 can be penetrated via the infrared light. The light absorbing layer 1221 can be made of the infrared penetrable material such as dye or coating, so that a lens 1321 of the detecting device 130 is directly disposed on the rear of the light absorbing module 122 for capturing the image. Further, the infrared penetrable material can be the organic dye material such as bromine-substituted dye and nitro-substituted dye, the black organic dye such as based on aniline or phenothiazine or the polymer dye such as polyvinyl chloride dye.

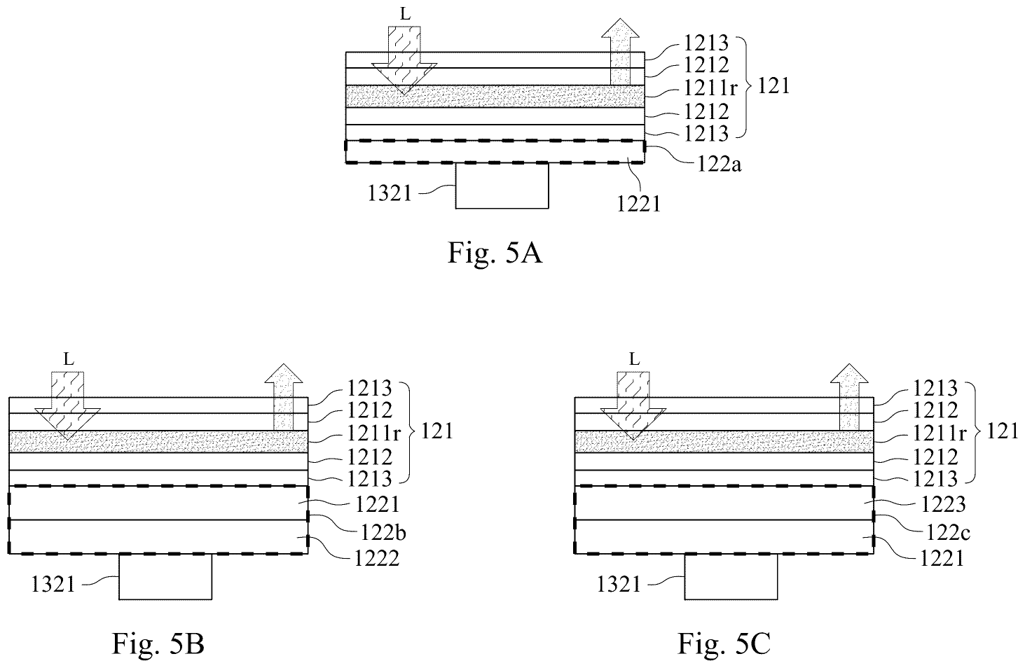

To further illustrate, FIG. 5A is a schematic view of a light absorbing module according to the 4th example of the present disclosure. In FIG. 5A, the light absorbing layer 1221 of the light absorbing module 122a is made of the coating-type infrared penetrable material. In detail, the light absorbing layer 1221 is formed by the physical vapor deposition (PVD) or the chemical vapor deposition (CVD), and the coating-type infrared penetrable material is deposited on a surface of the protective layer 1213 of the display module 121 away from the transparent conductive layer 1212.

Furthermore, in FIG. 5A, the light absorbing layer 1221 of the light absorbing module 122a can be also formed by applying the black matrix (BM) photoresist in the manufacturing process of the general color filter (CF). In detail, the BM photoresist can be mixed with the dye-type infrared penetrable material, and then coated on the surface of the protective layer 1213 of the display module 121 away from the transparent conductive layer 1212 to form the light absorbing layer 1221.

Please refer to FIG. 5B, wherein FIG. 5B is a schematic view of a light absorbing module according to the 5th example of the present disclosure. In FIG. 5B, the light absorbing module 122b can further include a substrate 1222 disposed on a side of the light absorbing layer 1221, and the substrate 1222 is adhered to a lens 1321 of the detecting device 130. The light absorbing layer 1221 of the light absorbing module 122b is made of the dye-type infrared penetrable material. The light absorbing layer 1221 is formed by mixing the dye-type infrared penetrable material and the optical adhesive and then coating on the substrate 1222. According to the 5th example, the substrate 1222 can be made of PET, polymethylmethacrylate (PMMA), polycarbonate (PC) or polyvinyl chloride (PVC), but the present disclosure is not limited thereto.

Please refer to FIG. 5C, wherein FIG. 5C is a schematic view of a light absorbing module according to the 6th example of the present disclosure. In FIG. 5C, the light absorbing module 122b can further include an adhesive layer 1223 disposed on a side of the light absorbing layer 1221, and the adhesive layer 1223 is adhered to the protective layer 1213 of the display module 121. The light absorbing layer 1221 of the light absorbing module 122b is also made of the dye-type infrared penetrable material. The light absorbing layer 1221 is formed by mixing the dye-type infrared penetrable material and the basic material such as the plastic material or the ABS resin. Further, the light absorbing layer 1221 and the display module 121 can be combined via the adhesive layer 1223. It should be mentioned that the infrared penetration efficiency of the light absorbing layer 1221 can be enhanced while maintaining the inherent properties of the plastic material by adjusting the ratio of the different materials during the process.

In FIG. 3, the detecting device 130 includes an infrared source module 131 and a camera module 132. The infrared source module 131 is configured to irradiate the user. The camera module 132 is configured to capture an area irradiated via the infrared source module 131 to form the image. According to the 1st example, the camera module 132 can be a camera with the infrared band, and the camera module 132 can preferably be a 3D time of flight (ToF) camera.

Moreover, according to the 1st example, the area irradiated via the infrared source module 131 is the palm of the user, and the image is formed by capturing the palm of the user via the camera module 132, but the present disclosure is not limited thereto.

Furthermore, the human veins have the light absorbing property, and the infrared light is strongly absorbed via the deoxygenated hemoglobin in the hemoglobin, so that the veins show as the black shadows so as to form a vein pattern for the camera module 132 to capture.

The controller 140 includes a pre-processing unit 141, an identification unit 142, a comparison unit 143 and a security device controller 144 which are signally connected. The pre-processing unit 141 is configured to obtain the image from the camera module 132, and the pre-processing unit 141 is configured to pre-process the image to remove a noise and enhance a vein characteristic in the image. The identification unit 142 is configured to analyze a characteristic of the image, which is pre-processed, to form a characteristic information. The comparison unit 143 is configured to compare the characteristic information with a verification characteristic which is pre-stored to generate a comparison score. The security device controller 144 is configured to control the electronic lock of the home security device body 110 according to the comparison score. In detail, when the comparison score is larger than a threshold, the security device controller 144 is configured to control the electronic lock of the home security device body 110 to unlock.

Furthermore, the user can put the palm on the front of the detecting device 130 to obtain the image via the detecting device 130, and the controller 140 is configured to pre-process the image and analyze and compare the characteristic thereof. When the comparing score is larger than the threshold, the controller 140 is configured to control the home security device body 110 to unlock. It should be mentioned that the comparing score larger than the threshold means that the user's identity verification is successful. The user can pull apart the display device 120 (as shown in FIG. 1), which is in front of the home security device body 110, and the door blade 111 of the home security device body 110 can be simultaneously opened. Therefore, the user's identity can be verified by the palm vein recognition via the detecting device 130 and the controller 140, so that the safety and the anti-counterfeiting can be further enhanced.

The controller 140 can further include a display controlling unit 145 configured to control the display device 120 to display the image information. The home security device 100 with the display device 120 can be used as the digital picture frame or the digital photo frame of the indoor decoration by displaying the image information via the display controlling unit 145 to control the display device 120. Therefore, in addition to hide the home security device body 110 behind the paintings or the photos so as to enhance the safety and the privacy, the user can upload or change the image information to be displayed by connecting the electronic device such as the mobile phone to the display controlling unit 145 at any time, so that the convenience of use can be increased.

Further, the display device 120 is a cholesterol liquid crystal display so as to maintain the display of the image information for a long time without consuming power. Moreover, the cholesterol liquid crystal display can provide the infrared light to penetrate, so that the infrared source module 131 and the camera module 132 disposed on the rear of the display device 120 can be configured to irradiate the user and capture the image of the user, respectively. Therefore, the home security device body 110 can be automatically controlled to unlock.

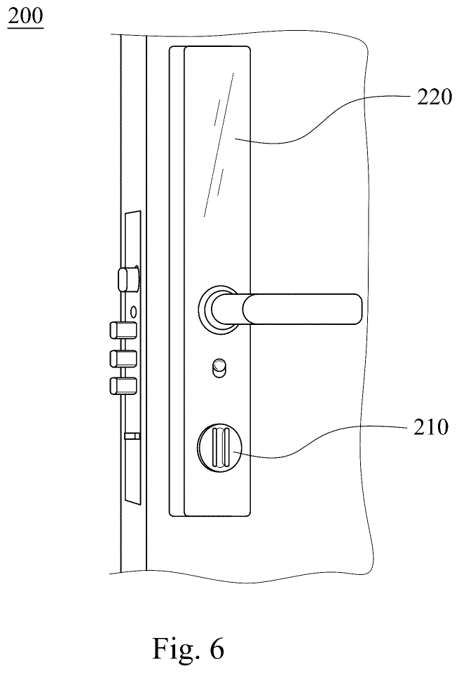

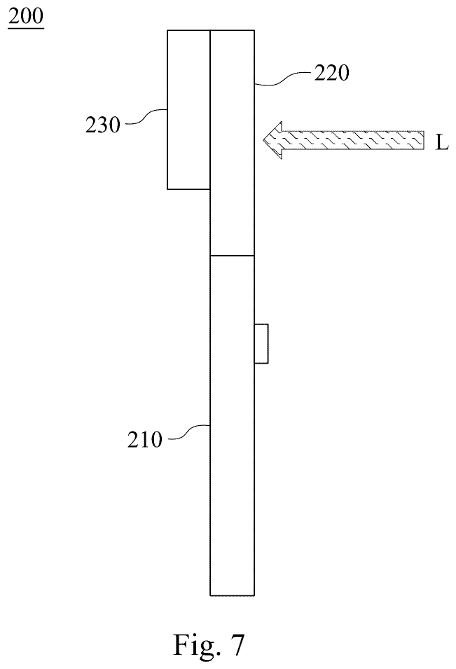

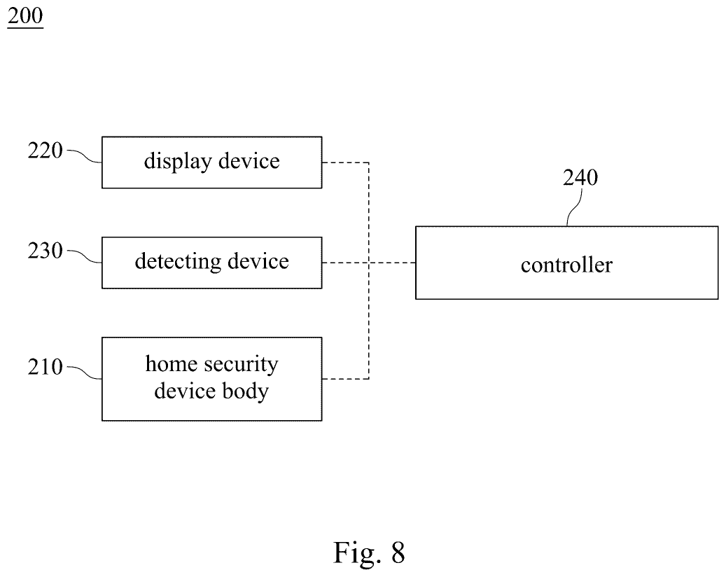

Please refer to FIGS. 6, 7 and 8, wherein FIG. 6 is a three-dimensional schematic view of a home security device with a display device according to the 7th example of the present disclosure; FIG. 7 is a cross-sectional schematic view of the home security device with the display device according to the 7th example in FIG. 6; and FIG. 8 is a block diagram of the home security device with the display device according to the 7th example of the present disclosure. The home security device 200 with the display device 220 includes a home security device body 210, the display device 220, a detecting device 230 and a controller 240. The display device 220 is disposed on a top of the home security device body 210, the detecting device 230 is disposed on a side of the display device 220, and the display device 220, the detecting device 230 and the home security device body 210 are integrally formed. The controller 240 is signally connected to the home security device body 210, the display device 220 and the detecting device 230.

According to the 7th example, the display device 220, the detecting device 230 and the controller 240 are the same as the display device 120, the detecting device 130 and the controller 140 according to the 1st example, respectively, and hence will not be described herein.

The difference between the 7th example and the 3rd example is that the home security device body 210 is a smart door lock. In particular, the controller 240 is configured to control the home security device body 210 whether to unlock according to the image obtained from the detecting device 230. After displaying the image information on the display device 220, the detecting device 230 which is behind thereof can be hidden so as to avoid being confirmed the position thereof via the outsiders. Comparing to the current smart door lock, the smart door lock according to the present disclosure is more difficult to crack so as to obtain the more privacy and the more security. In other possible example, the home security device body can also be entirely covered via the display device so as to obtain the effect of hiding the smart door lock to be more suitable for the users who need the requirements of high privacy.

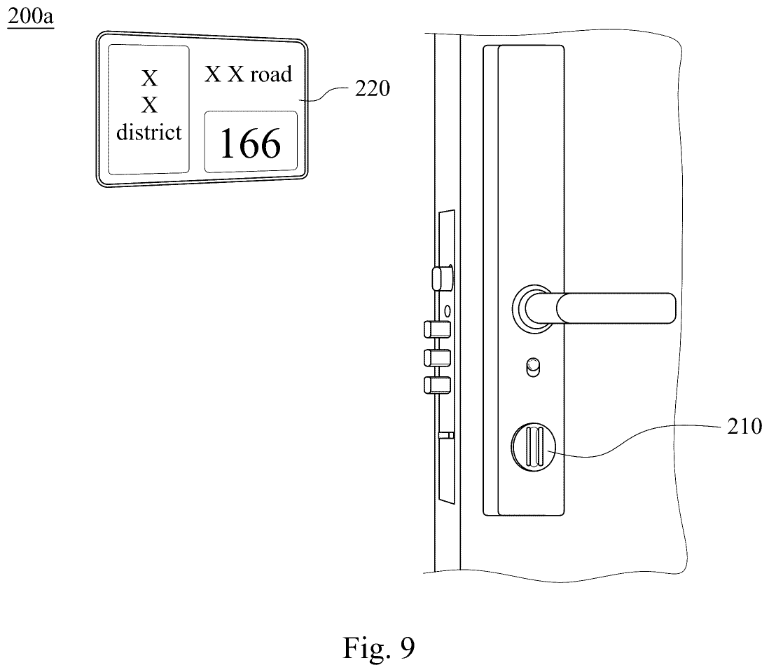

Please refer to FIGS. 7, 8 and 9, wherein FIG. 9 is a three-dimensional schematic view of a home security device with a display device according to the 8th example of the present disclosure. The difference between the home security device 200a with the display device 220 and the home security device 200 with the display device 220 according to the 7th example is the disposition of the display device 220 and the detecting device 230.

In detail, the display device 220 according to the 8th example can used as a smart doorplate disposed at the door of the house, and the user's house address is displayed by the image information. The detecting device 230 is disposed on the rear of the display device 220, and the controller 240 is configured to recognize the image detected via the detecting device 230 to control whether to unlock the home security device body 210. Furthermore, the controller 240 can be configured to control the display device 220 to switch the image information from the address to the words, such as ‘welcome’ or ‘welcome home’ after unlocking the home security device body 210.

Therefore, the outsiders, who are not the homeowner, cannot confirm the detecting device 230 whether obtains the function of opening the door lock from the appearance of the smart doorplate by hiding the location the detecting device 230, so that the purpose of the home protection can be further achieved.

According to the aforementioned examples, the home security device with the display device of the present disclosure has at least the following advantages. First, the home security device body can be hidden behind the paintings, the photos or the doorplate by displaying the image information on the display device via the display controlling unit, and the user can upload or change the image information to be displayed at any time, so that the convenience of use can be increased. Second, the display device is a cholesterol liquid crystal display so as to provide the infrared light to penetrate, so that the infrared source module and the camera module disposed on the rear thereof can be configured to irradiate the user and capture the image of the user, respectively. Therefore, the home security device body can be automatically controlled to unlock. Third, the user's identity can be verified by the vein recognition via the detecting device and the controller, so that the safety and the anti-counterfeiting can be further enhanced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A home security device with a display device, comprising:
a home security device body;
the display device disposed on a side of the home security device body, and comprising:
at least one display module comprising a pixel matrix layer; and
a light absorbing module disposed on a side of the at least one display module;
a detecting device disposed on a side of the display device so as to obtain an image of a user; and
a controller signally connected to the home security device body, the display device and the detecting device, the controller configured to control the display device to display an image information, and the controller configured to recognize the image to confirm whether to unlock the home security device body.

2. The home security device with the display device of claim 1, wherein the detecting device comprises:
an infrared source module configured to irradiate the user; and
a camera module configured to capture an area irradiated via the infrared source module to form the image.

3. The home security device with the display device of claim 2, wherein the controller comprises:
a pre-processing unit configured to pre-process the image to remove a noise;
an identification unit signally connected to the pre-processing unit, and the identification unit configured to analyze a characteristic of the image to form a characteristic information; and
a comparison unit signally connected to the identification unit, and the comparison unit configured to compare the characteristic information with a verification characteristic which is pre-stored to generate a comparison score.

4. The home security device with the display device of claim 3, wherein the controller further comprises:
a security device controller configured to control the home security device body according to the comparison score;
wherein when the comparison score is larger than a threshold, the security device controller is configured to control the home security device body to unlock.

5. The home security device with the display device of claim 2, wherein the camera module is a 3D time of flight camera.

6. The home security device with the display device of claim 1, wherein the controller comprises:
a display controlling unit configured to control the display device to display the image information.

7. The home security device with the display device of claim 1, wherein the display device is a cholesterol liquid crystal display.

8. The home security device with the display device of claim 1, wherein the at least one display module further comprises:
two transparent conductive layers disposed on two surfaces of the pixel matrix layer, respectively; and
two protective layers disposed on two surfaces of the two transparent conductive layers away from the pixel matrix layer, respectively.

9. The home security device with the display device of claim 1, wherein the light absorbing module comprises:
a light absorbing layer configured to absorb a visible light penetrating through the at least one display module;
a substrate disposed on a side of the light absorbing layer, and the substrate adhered to a lens of the detecting device; and
an adhesive layer disposed on a side of the light absorbing layer, and the adhesive layer adhered to a protective layer of the at least one display module.

10. The home security device with the display device of claim 1, further comprising:
a frame disposed on a periphery of the display device.

11. The home security device with the display device of claim 1, wherein the at least one display module is plurality, and the display modules are stackedly disposed or parallel disposed.
